(19) United States
(12) Patent Application Publication
(10) Pub. No.: US 2016/0128469 A1
(43) Pub. Date: May 12, 2016

(54) PANEL COMPONENTS AND SYSTEMS

(71) Applicant: Herman Miller, Inc., Zeeland, MI (US)

(72) Inventors: John Matthai, Zeeland, MI (US); David R. Johnson, Zeeland, MI (US); Kevin Mulder, Zeeland, MI (US)

(21) Appl. No.: 14/936,672

(22) Filed: Nov. 9, 2015

Related U.S. Application Data
(60) Provisional application No. 62/076,950, filed on Nov. 7, 2014.

(51) Int. Cl. A47B 47/00; A47B 47/05; F16B 12/32; A47B 13/00

(52) U.S. Cl. CPC A47B 47/0091; A47B 13/003; A47B 47/05; F16B 12/32

(57) ABSTRACT

A panel system includes a first panel having a first frame and a first cladding connected to the first frame and a second panel having a second frame and a second cladding connected to the second frame. Various components are used to secure the panels together, to secure the claddings, and to stabilize the panels. The panels can be arranged in different configurations to create a variety of work areas.

### RELATED APPLICATION(S)

This application is based on U.S. Provisional application Ser. No. 62/076,950, filed Nov. 7, 2014, the disclosure of which is incorporated herein by reference in its entirety and to which priority is claimed.

### BACKGROUND

The present invention relates to panels, components and systems, for example panels and panel systems used to divide spaces, for example work areas.

Various walls, worksurfaces, screens, and other components can make up a work area. These components need to be durable and with little or no gaps so as to preclude the accumulation and intrusion of various fluids, dirt and other contaminants. At the same time, the systems must be able to deliver power and data to the users.

Workspaces are typically “stick built,” or constructed on site from individual pieces of millwork. While such systems may be robust, with reduced seams and gaps, they are relatively expensive and are not adaptable, meaning they cannot be disassembled and reconfigured to accommodate different needs. Moreover, the initial construction can be time consuming and labor intensive.

### SUMMARY

According to an exemplary embodiment, a panel system includes a first panel having a first frame and a first cladding connected to the first frame and a second panel having a second frame and a second cladding connected to the second frame. A connector is provided for clamping the frame of the first panel and the frame of the second panel together. The connector includes a first opening and a second opening. A first fastener extends through the first opening of the connector and a second fastener extends through the second opening of the connector. Rotation of the first fastener or the second fastener moves the first panel relative to the second panel.

According to another embodiment, a panel includes a frame, a leg, and an anchor foot The frame has an upper portion and a downwardly extending lower support. The leg is connected to the lower support and has a stem and a base. The anchor foot has a slot for receiving at least a portion of the leg and an anchor hole.

According to another embodiment, a panel includes a frame having a first side and a second side, and an upper rail. An attaching device is fastened to the upper rail. A first cladding is secured to the first side of the frame by the attaching device and a second cladding is secured to the second side of the frame by the attaching device.

Other embodiments are directed to the individual components of a panel system, as well as the work areas that can be created utilizing the features described herein.

The foregoing paragraphs have been provided by way of general introduction, and are not intended to limit the scope of the following claims. The various preferred embodiments, together with further advantages, will be best understood by reference to the following detailed description taken in conjunction with the accompanying drawings.

Other aspects of the invention will become apparent by consideration of the detailed description and accompanying drawings.

### BRIEF DESCRIPTION OF THE DRAWINGS

FIG. 1 is a perspective view of a workstation having a plurality of panels in a first layout.

FIG. 2 is a perspective view of a workstation having a plurality of panels in a second layout.

FIG. 3 is a perspective view of one of the panels of the workstations of FIGS. 1 and 2.

FIG. 4 is a perspective view of a propeller workstation layout.

FIG. 5A is a perspective view of a workstation in a third layout, having a worksurface at a lowered position.

FIG. 5B is a perspective view of the workstation of FIG. 5A having the worksurface at a raised position.

FIG. 6 is a perspective view of a connector coupled to a plurality of panels of the workstations of FIGS. 1 and 2.

FIG. 7 is a perspective view of the connector of FIG. 6.

FIG. 8 is a perspective view of a lower connector coupled to a plurality of panels of the workstations of FIGS. 1 and 2.

FIG. 9 is a perspective view of the lower connector of FIG. 8.

FIG. 10 is a perspective view of an anchor foot coupled to one of the panels of the workstations of FIGS. 1 and 2.

FIG. 11 is a perspective view of the anchor foot of FIG. 10.

FIG. 12 is a perspective view of an attachment device coupled to a plurality of claddings of one of the panels of the workstations of FIGS. 1 and 2.

FIG. 13 is a side view of the attachment device of FIG. 12

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

It should be understood that the term “plurality,” as used herein, means two or more. The term “longitudinal,” as used herein means of or relating to length or the lengthwise direction 2, for example along a length of a panel. The term “lateral,” as used herein, means directed between or toward (or perpendicular to) the sides of a panel, e.g., a lateral direction 4. The term “coupled” means connected to or engaged with, whether directly or indirectly, for example with an intervening member, and does not require the engagement to be fixed or permanent, although it may be fixed or permanent. The term “transverse” means extending across an axis or surface, including but not limited to substantially perpendicular to the axis or surface.

It should be understood that the use of numerical terms “first,” “second,” “third,” etc., as used herein does not refer to any particular sequence or order of components (e.g., consecutive); for example “first” and “second” panels or frames may refer to any panel or frame members of a particular layout unless otherwise specified.

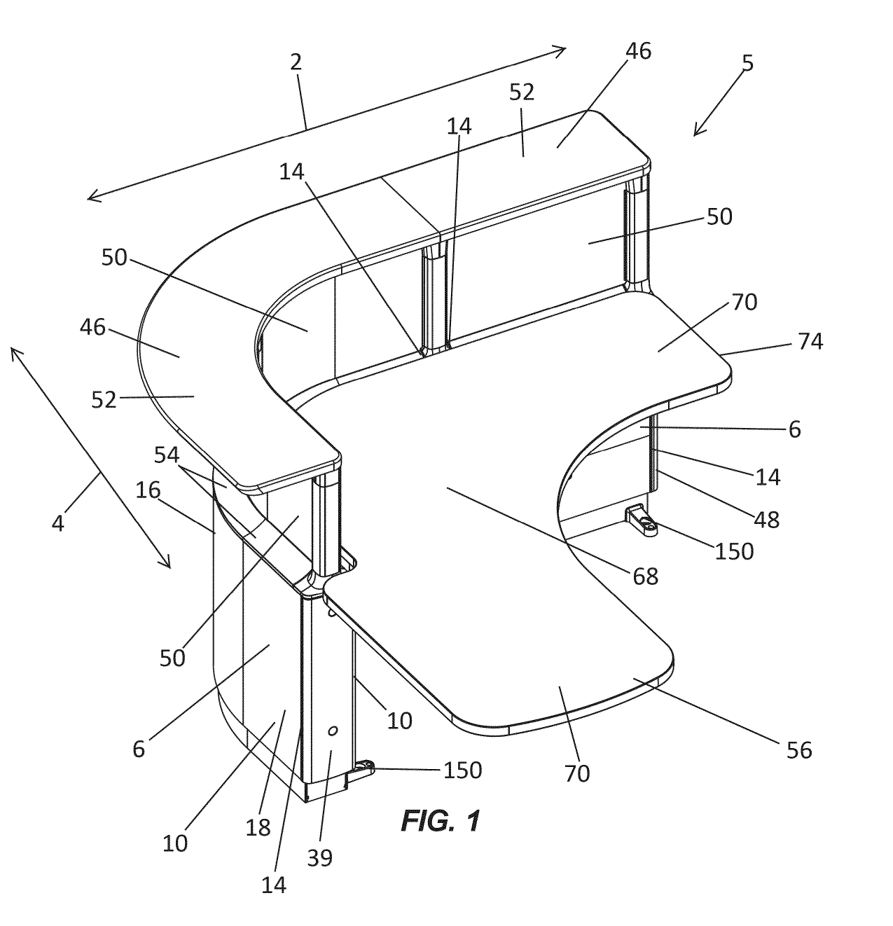

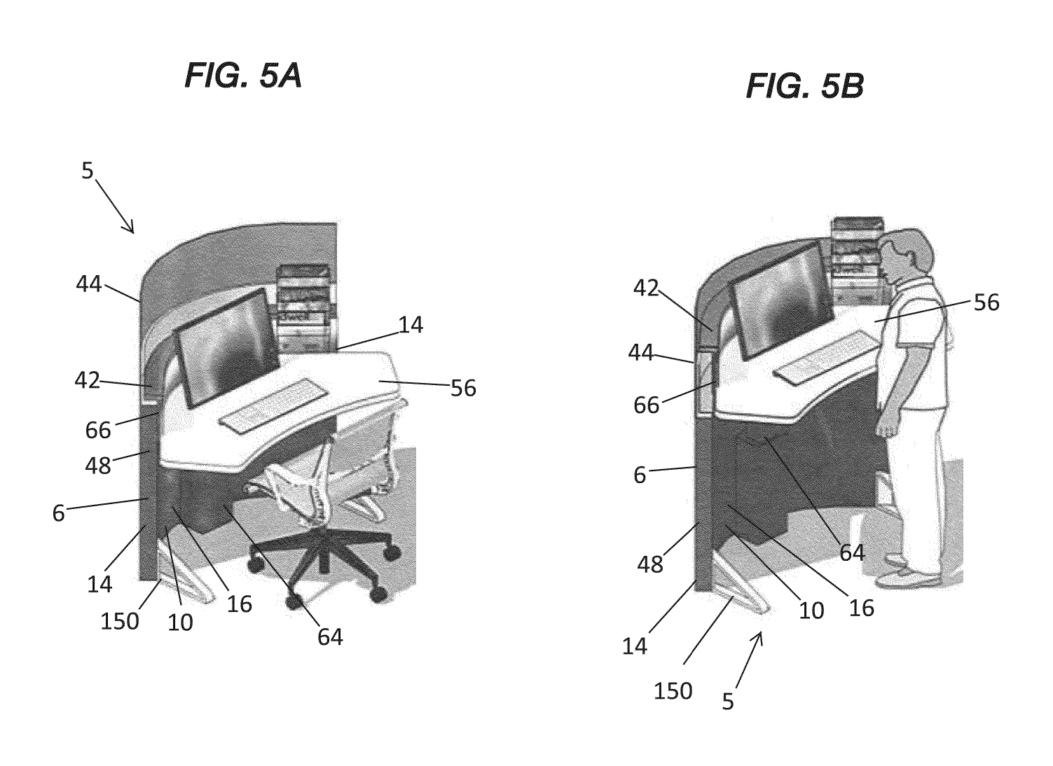

FIGS. 1-5B show exemplary workstations 5 different layouts. The workstations 5 include one or more panels 6. The panels 6 may be configured with different components, and accessories, and may be connected in some embodiments in an end-to-end configuration. In various exemplary embodiments, the panel 6 includes an interior frame 8 and a cladding 10 disposed on each side of the frame 8. The panel 6 includes two opposite sides and may be curved, linear, or a combination therefore. Different panels 6 can be connected together to form various configurations between two opposite ends 14. For example, the panels 6 may have a boomerang shape with a curved intermediate portion 16 and linear end portions 18 (as shown in FIGS. 5A and 5B), a semi-circular shape, or another shape having a first side with a concave side surface and an opposite second side with a convex surface.

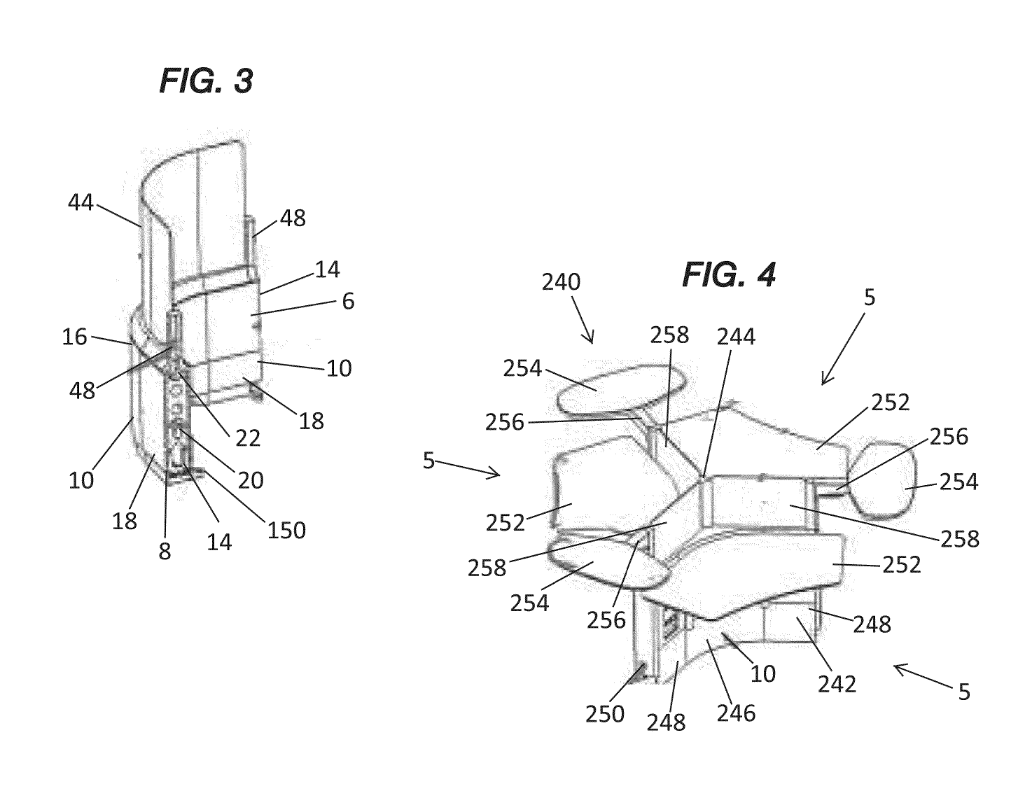

Referring to FIGS. 1-3, the frame 8 extends from one end 14 of the panel 6 to the other end 14. The frame 8 may include frame stiles (not illustrated) arranged along the length of the frame 8. The stiles may be tubular, or have other cross-sectional shapes such as a C, H or Z channel. As shown in FIG. 3, the ends of the frame 8 may have a plurality of through openings 20, which provides a pass-through at the ends 14 of the frame 8 for various power cords, conduit, data and utility lines, fluid and gas lines, etc. The through openings 20 are substantially aligned when two adjacent panels 6 are arranged end-to-end.

The frame 8 further includes an upper frame rail 22 extending from the opposite ends 14 of the panel 6. Various other rails and stiles may also be incorporated into the frame 8. In the curved embodiment, the upper frame rail 22 may have a curved portion and define the curvature of the overall panel 6. The upper frame rail 22 may be configured with a plurality of knock-outs, which may form through-openings arranged along the length thereof. The through-openings of the upper frame rail 22 provide a vertical pass-through for various power cords, conduit, data and utility lines, fluid and gas lines, etc. The upper frame rail 22 may be secured to the stiles by welding, or with fasteners such as bolts, brackets, folding tabs, and/or combinations thereof. The frame 8 may also include a lower frame rail, or other intermediate rails, that extend from the opposite ends 14 of the panel 6 and are curved similar to the upper frame rail 22.

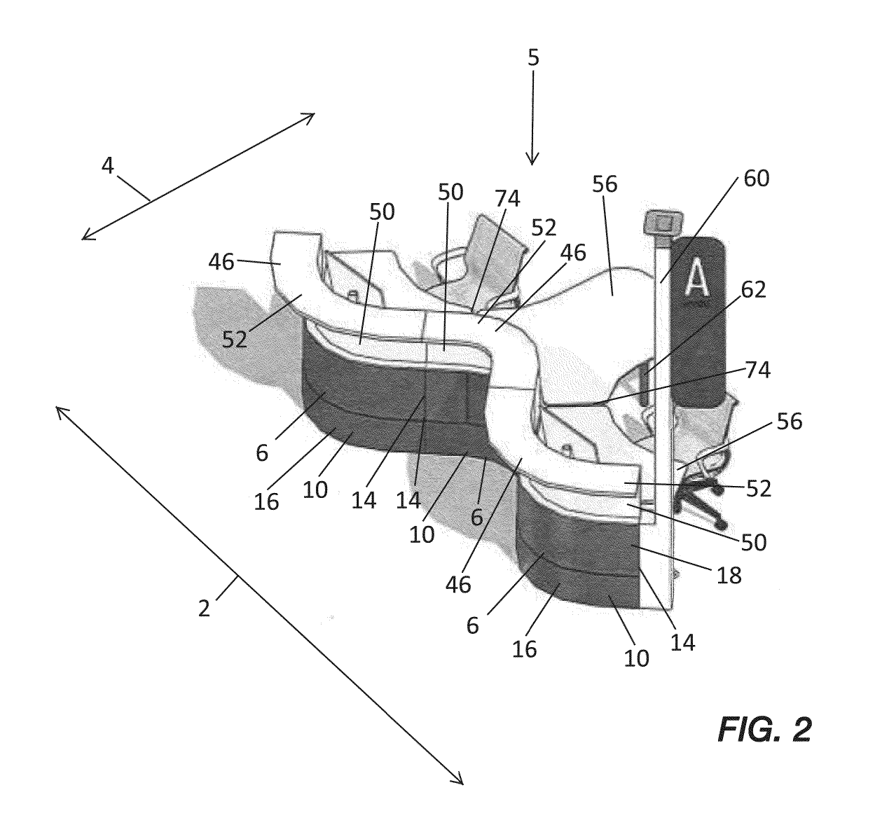

The panel 6 may have end caps 39 secured to and covering the ends 14 of an exposed panel 6 at the end of a workstation 5. A power pole 60, shown in FIG. 2 may also be secured to and cover the end 14 of a panel 6. Power, data and utility lines may be routed from the ceiling or floor to a panel 6, and thereafter to other panels 6, by the power pole 60. The top of the panel 6 is covered by one or more components or accessories, including for example a top cap 42, a screen 44, or a worksurface 46, such as a transaction top, or combinations thereof. For example, as shown in FIG. 3, the screen 44 may be supported by a pair of end brackets 48, or bayonets, that extend upwardly from the panel 6. The screens 44 may be curved or linear, or includes curved and linear portions, depending on the shape of the underlying panel 6 to which they are secured. The screens 44 may be see-through, opaque or light impervious, and may be made of glass, plastic, wood, or various tackable and rewritable materials, such as white board.

Referring to FIG. 1, the worksurface 46 may have a vertical support wall 50 extending upwardly from the underlying panel 6. A horizontal worksurface 52 is supported by the wall 50 and cantilevered brackets 54. In one embodiment, the worksurface 52 has a relatively uniform width and extends outwardly from the convex side of the panel in a cantilevered fashion such that it extends outwardly from the plan foot print of the panel 6. Alternatively, the worksurface 52 may extend inwardly from the concave side, or extend from both sides.

A worksurface 56 may also extend from the top of the panel 6 (e.g., without the support wall 50. The worksurface 56 may be shaped and configured to nest within the concave side 7A of the panel 6, or along the convex side 7B. The worksurface 56 may form a general Y-shape, and include an extended cantilevered portion supported by a leg 62 spaced apart from the panel 6.

Referring to FIGS. 5A and 5B, the worksurface 56 may height adjustable relative to the panel 6. For example, the worksurface 56 is supported by one or more extendible support columns 64. The worksurfaces 56 may include a back wall 66 and a shelf 42 or top cap that move with the worksurface 56 and eliminate any gaps along the rear edge of the worksurface 56 (e.g., between the back wall 66 and the screen 44). As shown in FIG. 1, the worksurface 56 may include a first portion 68 nested within the curved portion of the panel 6, and a second portion 70 that extends longitudinally from the ends 14 of the panel 6, and in one embodiment, surrounds the end 14 of the panel 6 and extends outwardly in both sideways directions relative to the panel 6. In certain embodiments, the worksurfaces 56 have side edges 74 that mate when curved panels 6 are arranged in a serpentine configuration, with undulating curvatures, or when arranged in scalloped configuration. Likewise, worksurfaces 56 connected to linear panels 6 have side edges 74 that are aligned and mate the side edges 74 of adjacent curved panels 6.

In an exemplary embodiment, the panels 6 each include a first and second cladding 10 secured to opposite sides of the frame 8, as described in greater detail below. The cladding 10 may be curved, linear, or any combination thereof, to match the curvature of the frame 8. The cladding 10 may be configured as a single piece or multiple pieces. For example, the cladding 10 may be configured with a curved section and a pair of linear sections corresponding to the shape of the adjacent frame 8. The cladding 10 may extend from a top of the frame 8 to the floor, or a kick plate portion may be provided along the bottom of the panel 6. The kick plate may be secured to the frame 8 behind the cladding 10 with fasteners, welding, mechanical tabs, and other devices. The kick plate is visually aligned with the cladding 10 with pins, splines, or other devices. In one embodiment, the cladding 10 is continuous from the top to the bottom of the panel 6, and from one end 14 to the other end 14 of the panel 6 so as to not introduce any gaps or seams. The cladding 10 may be made of wood, metal, such as steel, or any other suitable material.

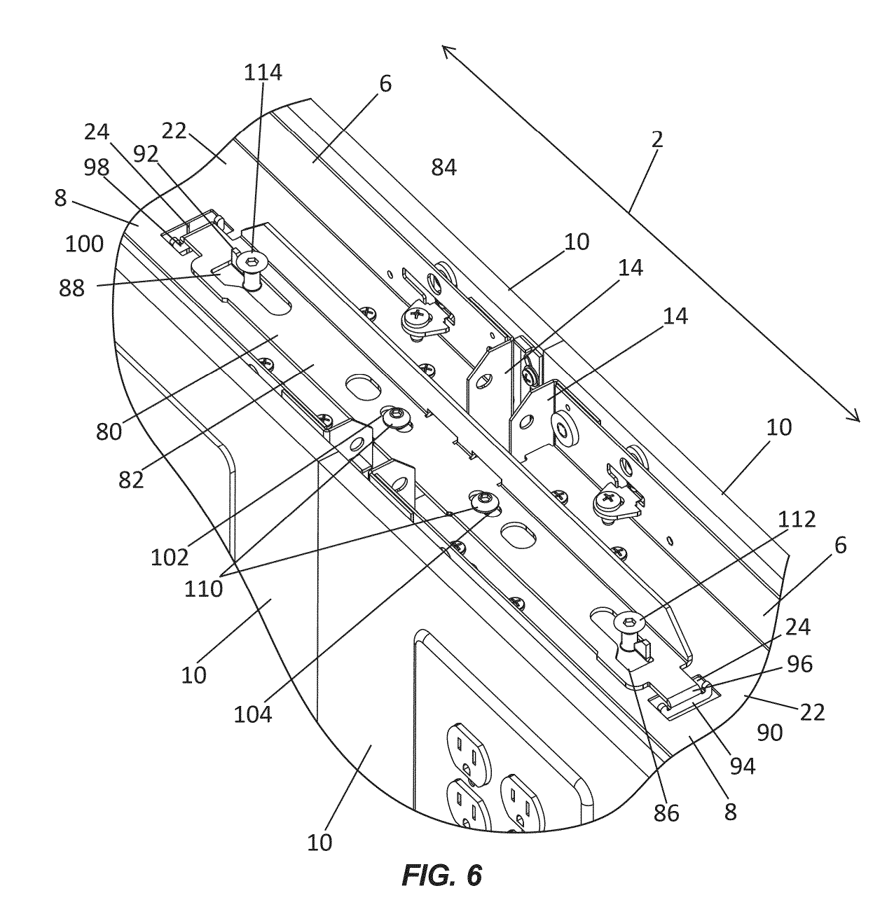

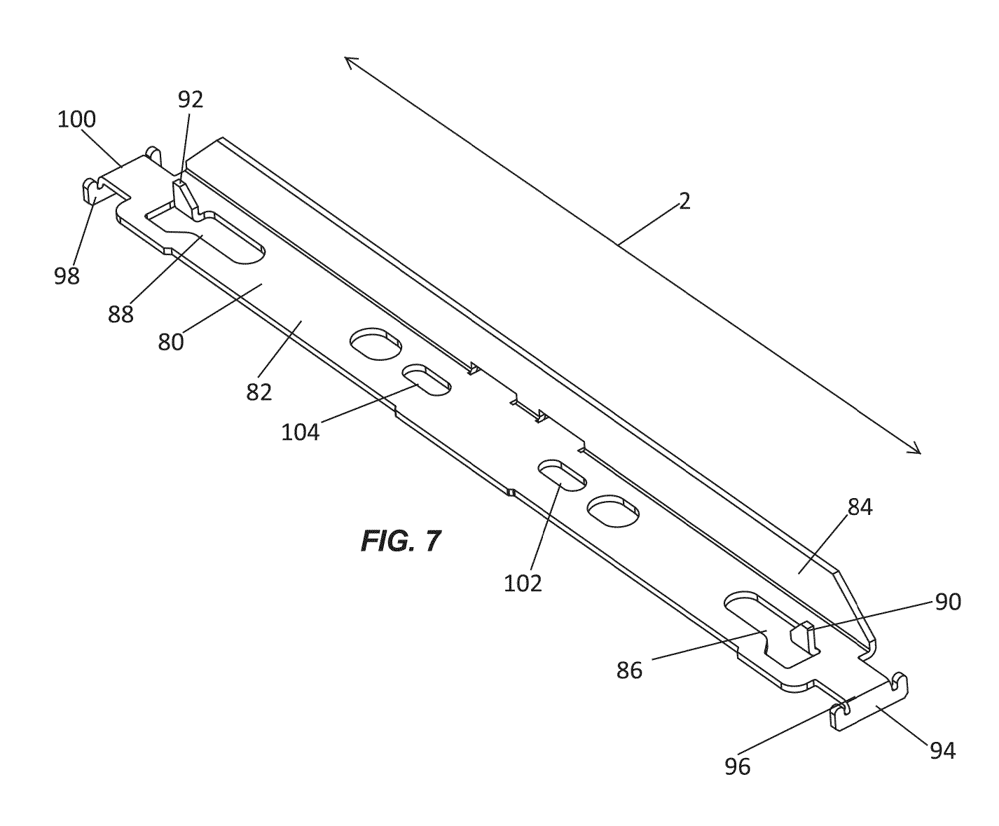

According to certain embodiments, a connector 80 is used to connect a first panel 6 and a second panel 6, as shown in FIGS. 6 and 7. The connector 80 includes a base 82 and a side 84 extending from the base 82. The base 82 includes a first opening 86 and a second opening 88. A first inclined ramp 90 extends from the base 82 adjacent the first opening 86 and a second inclined ramp 92 extends from the base 82 adjacent the second opening 88. A first alignment tab 94 extends from a first end 96 of the base 82 and a second alignment tab 98 extends from a second end 100 of the base 82. The connector 80 also includes a third and fourth opening 102, 104 for receiving a fastener 110.

The connector 80 is connected to the frame 8 of a first panel 6 and a second panel 6, for example the upper rails 22 of the frame 8, with the alignment tabs 94, 98 extending through openings 24 in the upper rails 22. A first fastener 112 and a second fastener 114 are positioned in the first and second openings 86, 88, respectively, and are threadably connected to the frame 8. Rotation of the first and second fasteners 112, 114 causes the fasteners 112, 114 to engage the respective inclined ramp 90, 92. For example, the head of the fastener 112, 114 engages the ramp 90, 92 as the fastener 112, 114 is rotated into the upper rail 22. The head of the fastener 112, 114 can have an inclined or angled surface and the ramp 90, 92 can be configured to have a mating angle.

Engagement of the fastener 112, 114 with the ramp 90, 92 causes the fastener 112, 114 to push on the ramp 90, 92, moving the connector 80 and thus one or more of the panels 6. For example, rotation of the first fastener 112 can cause the connector 80 to move to the right, while rotation of the second fastener 114 can cause the connector 80 to move to the left. When the panels 6 reach a desired position respective to one another, set screws 110 can be placed through the third and fourth openings 102, 104 to secure the position of the panels 6. The connector 80 can therefore be used to move and clamp the first and second panels 6 together, reducing or eliminating gaps between panels 6. In certain embodiments, the panels 6 can be moved until edges of the claddings 10 are touching or compressed together. The edges of the cladding 10 can be flat, as shown in FIG. 6, or have complimentary angles to further reduce the appearance of a seam.

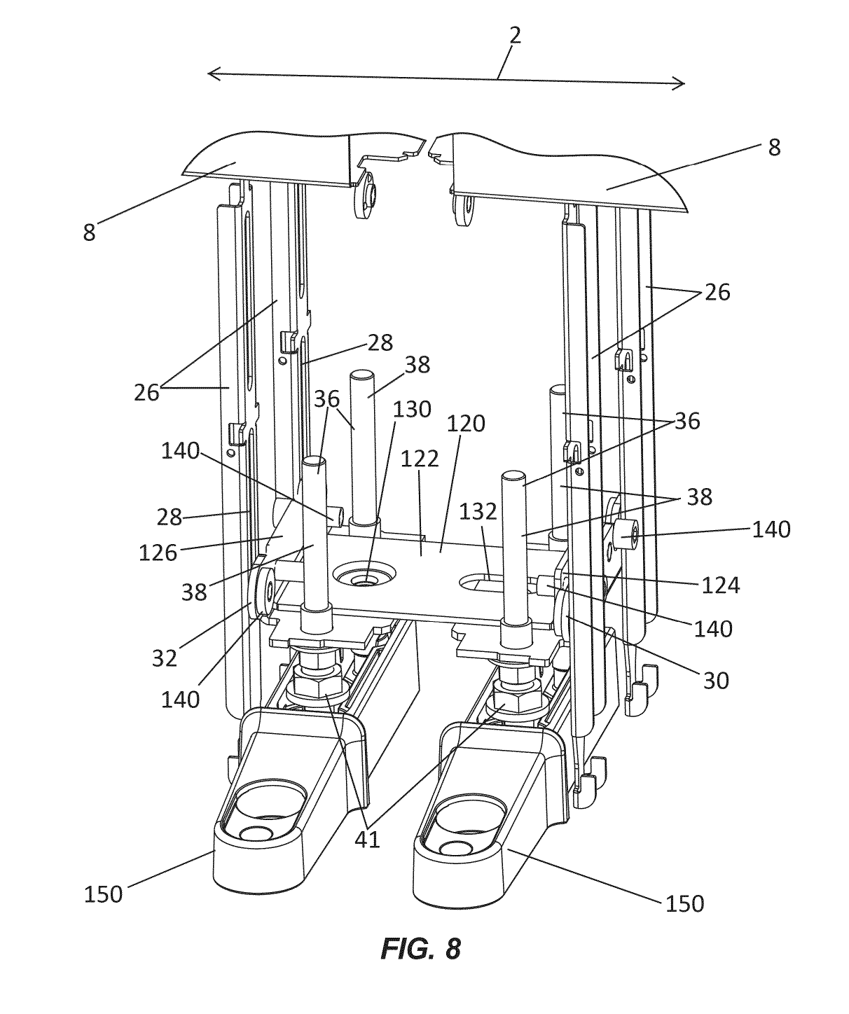

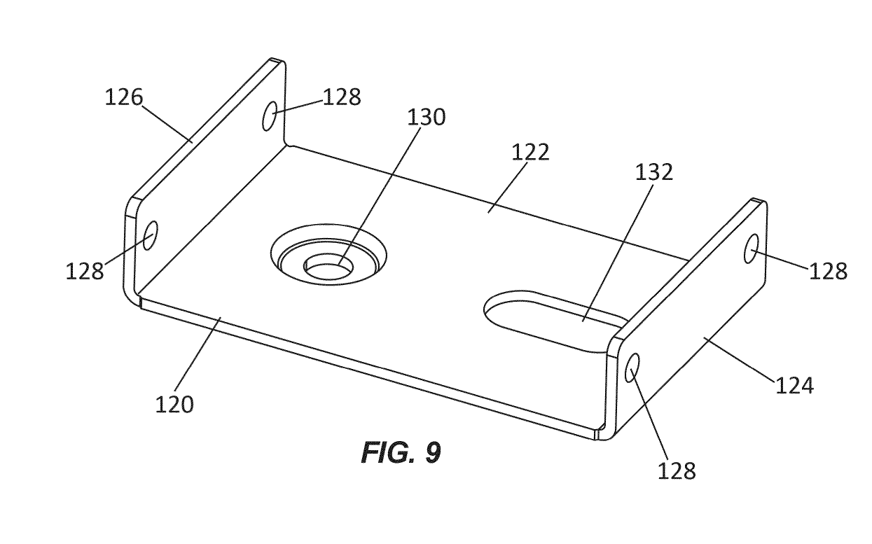

The panels 6 can also be connected by a lower connector 120, as shown in FIGS. 8 and 9. The lower connector 120 includes a base 122, a first side 124, and a second side 126. The first and second sides 124, 126 include a set of openings 128 to allow the lower connector 120 to be connected to the frame 6. One or more openings 130, 132 can be provided in the base 122 to allow for additional connections, for example a circular aperture 130 and a slot 132 can be provided to allow for an adjustable connection.

As best shown in FIG. 8, the frame 8 includes one or more lower supports 26 extending down toward a floor. The lower supports 26 each include a slot 28 to receive a fastener 140. A first bracket 30 is connected to the lower supports 26 of the first panel 6 and a second bracket 32 is connected to the lower supports 26 of the second panel 6. The lower connecter 120 is connected to the first and second brackets 30, 32, for example through one or more fasteners 140, securing the lower position of the frames 6. Fasteners 140 can be placed through the openings 128 in the side walls 124, 126 as well as the openings 130, 132 in the base 122. The slots 28 allow the position of the lower connector 120 to vary relative to the brackets 30, 32.

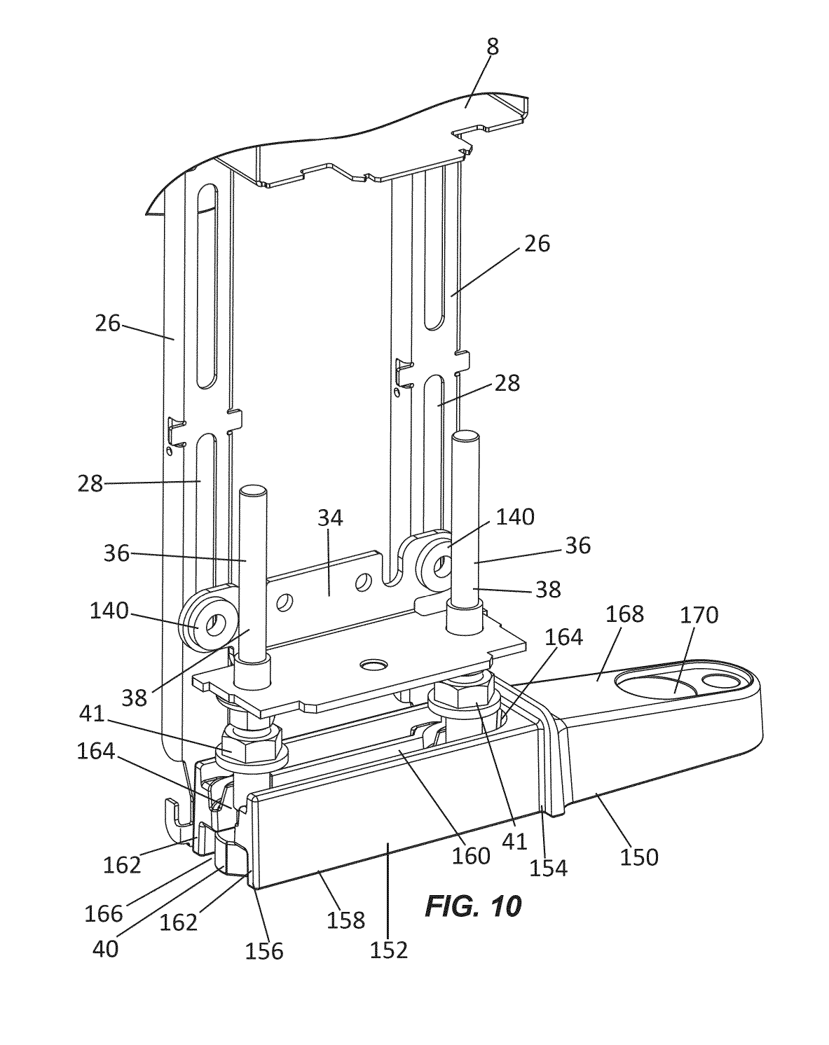

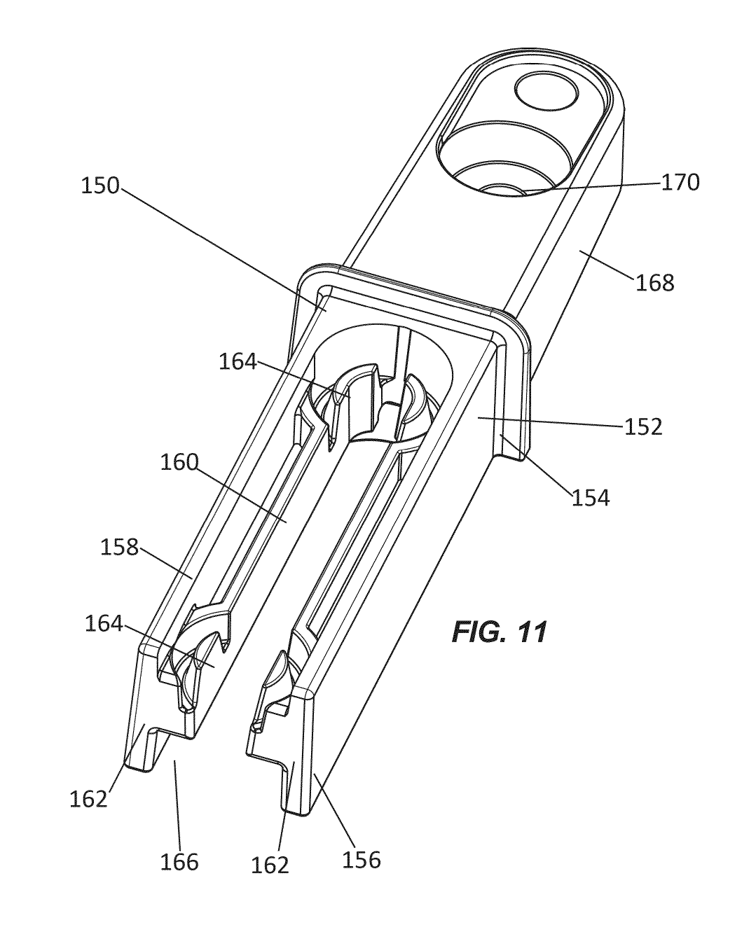

FIGS. 8, 10, and 11 depict an exemplary embodiment of a panel 6 that utilizes an anchor foot 150 to help support the frame 8. The anchor foot 150 includes an elongated housing 152 having opposite first and second ends 154, 156 spaced apart in a longitudinal direction, a top, a bottom and opposite sides. The anchor foot 150 has a first portion 158 with a slot 160 that extends from the first end 154 of the housing 152 toward the second end 156, so as to define a pair of tines 162. One or more recesses 164, for example curvilinear recesses 164, can be formed in the anchor foot 150, for example over and around the slot 160. In other alternative embodiments, the anchor foot 150 has more than one slot 160, for example a pair of parallel slots 160 defining three tines 162. A channel 166 is formed in the anchor foot 150 underlying the slot 160. The channel 166 has a width greater than the width of the slot 160. A second portion 168 of the anchor foot 150 includes an anchor hole 170.

Each panel 6 has one or more legs 36 connected to the lower supports 26 by a bracket 30, 32, 34. Each leg 36 includes a stem 38 and a base 40. The base 40 can be a glide or have another configuration depending on the floor surface. The base 40 may be adjusted to vary the vertical height of the frame 8, for example by having the stem 38 threadably engage the frame 8. The anchor foot 150 is slid under the frame 8 and straddles the pair of legs 36. The stems 38 of each leg 36 are received in and extend upwardly through the slot 160, with the bases 40 received in the channel 166 and underlying the upper surface. A jam nut 41 can be tightened down on the stem 38 onto the anchor foot 150 and into the recess 166.

In an exemplary embodiment, the anchor foot 150 extends outwardly beyond the side surface of the cladding 10 and panel 6, such that the anchor hole 170 is exposed and lies outside of the plan footprint of the panel 6. The installer may pre-drill a hole in the floor in alignment with the anchor hole 170. An anchor member, such as a concrete screw, may be installed through the anchor hole 170 and into the floor. Due to the accessibility of the anchor hole 170 outside of the footprint of the panel 6, a hammer drill may be used for the anchoring. The anchor foot 150, when installed, provides rigidity and robustness to the panel 6 and panel systems.

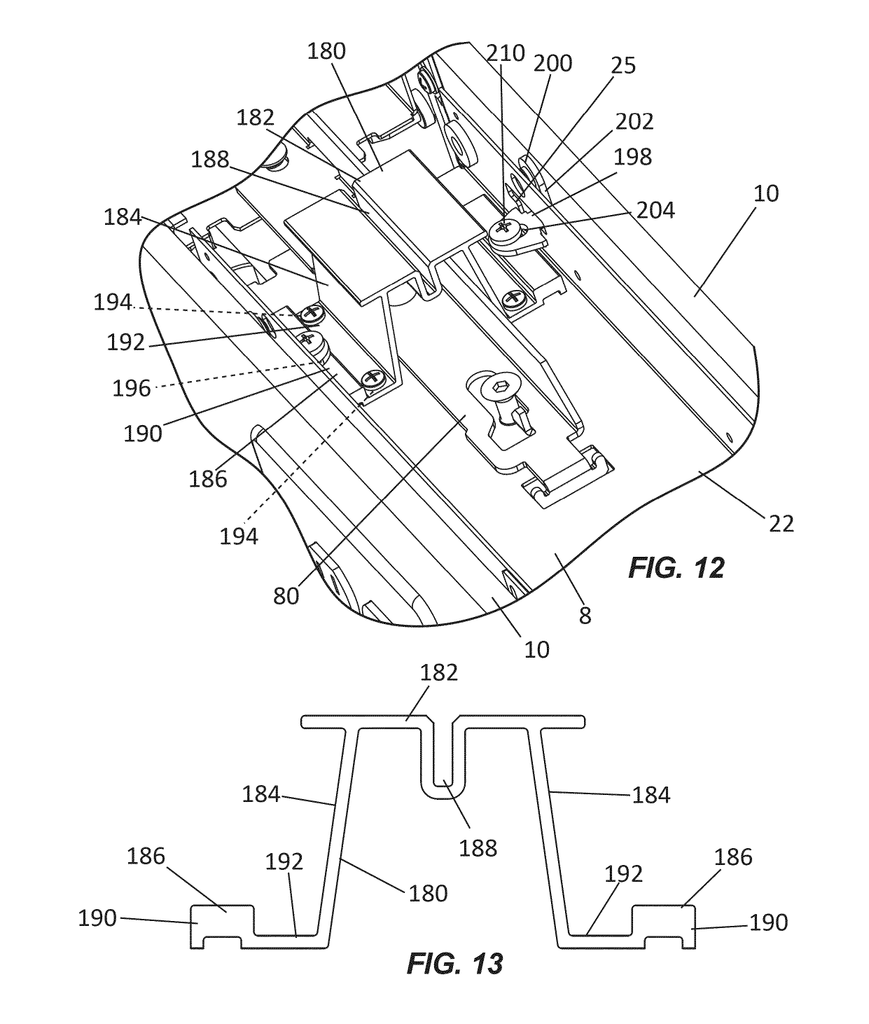

FIGS. 12 and 13 show an exemplary attaching device 180 to position and connect the claddings 10 to the frame 6. The attaching device 180 has a middle portion 182, a pair of side portions 184 extending from the middle portion 182, and a pair of bottom portions 186 extending from respective side portions 184. The middle portion 182 includes a substantially u-shaped channel 188, although other types of channels may be used or the channel 188 eliminated. The bottom portion 186 includes an outer member 190 and an inner member 192, with the inner member 192 positioned below the outer member 190. The bottom portion 186 includes a set of openings 194, 196 to connect the attaching device 180 to the frame 6 and to the claddings 10. For example, the inner member 192 includes a pair of openings 194 to connect to the frame 6 and the outer member 190 includes an opening 196 to connect to a cladding 10.

The attaching device 180 is connected to the frame 6, for example on an upper rail 22 over the connector 80 as shown in FIG. 12. A substantially L-shaped bracket 198 has a first portion 200 connected to the cladding 10 and a second portion 202 that extends through a slot 25 in the upper rail 22. An opening 204 on the second portion 202 of the bracket 198 is aligned with the opening 196 in the outer member 190 and the bracket 198 is secured to the outer member 190 with a fastener 210. The outer member 190 is raised from the inner member 192 so that the top edge of the cladding 10 will extend above the top edge of the upper rail 22. The channel 188 in the middle portion 182 can be used to connect various components, such as screens 44, dividers, or a top cap 42.

Referring to FIG. 4, a propeller unit 240 is shown as including three concave side walls or surfaces 242, which may be defined by a cladding 10, joined to an interior frame 244. The side walls 242 may include an intermediate curved portion 246 and linear end portions 248. In one embodiment, the side walls 242 include the same cladding 10 used on the panels 6. The ends of the side walls meet at common junctions or nodes 250, which may be covered with an end cap or cover. A primary worksurface 252 may be nested adjacent each side wall 242, with the worksurfaces 252 being height adjustable. In addition, an auxiliary worksurface 254 may be supported at one or more of the nodes 250 with a cantilevered bracket 256, with the worksurface 254 being fixed or height adjustable. Curved, linear or curvilinear screens 258 may be disposed along the tops of the side walls 242 and meet at a central axis A, and define three different workstations 5. Alternatively, a topper or top cap may be disposed over the top of each side wall 242, and move with the primary worksurface 252. In another embodiment, two propeller units 240 may be joined by a panel, for example a linear wall, connected to a pair of spaced apart nodes 250, with the panel connected to the unit 240 with one or more of the connectors 80, 120 described above.

Referring to FIGS. 1-5B, the panels 6 may be arranged in a variety of different layouts, including both the curved and linear panels 6. For example, the curved panels 6 may be arranged in stand-alone configuration, as illustrated in FIGS. 5A, 5B, in a scalloped pattern to define a plurality of in-line workstations, or in a sinuous, serpentine pattern, as illustrated in FIG. 2. In any of the configurations, the curved panels 6 provide unique spaces on both sides of the panel 6 line that serve multiple functions. The curved panels 6 may be configured with a bench, with two units facing each other, or combined with a linear panel 6 to define a booth or seating area, having screens 44 or transaction tops. In the healthcare environment, the configurations may provide for nurse stations, file pass-throughs, a telepresence workstation, exterior and nodal touchdown stations, registration stations, and ADA workstations.

The foregoing detailed description of the certain exemplary embodiments has been provided for the purpose of explaining the general principles and practical application, thereby enabling others skilled in the art to understand the disclosure for various embodiments and with various modifications as are suited to the particular use contemplated. This description is not necessarily intended to be exhaustive or to limit the disclosure to the exemplary embodiments disclosed. Any of the embodiments and/or elements disclosed herein may be combined with one another to form various additional embodiments not specifically disclosed. Accordingly, additional embodiments are possible and are intended to be encompassed within this specification and the scope of the appended claims. The specification describes specific examples to accomplish a more general goal that may be accomplished in another way.

As used in this application, the terms “front,” “rear,” “upper,” “lower,” “upwardly,” “downwardly,” and other orientational descriptors are intended to facilitate the description of the exemplary embodiments of the present application, and are not intended to limit the structure of the exemplary embodiments of the present application to any particular position or orientation. Terms of degree, such as “substantially” or “approximately” are understood by those of ordinary skill to refer to reasonable ranges outside of the given value, for example, general tolerances associated with manufacturing, assembly, and use of the described embodiments.

What is claimed is:

1. A panel system comprising:
a first panel having a first frame and a first cladding connected to the first frame;
a second panel having a second frame and a second cladding connected to the second frame;
a connector for clamping the frame of the first panel and the frame of the second panel together, the connector including a first opening and a second opening
a first fastener extending through the first opening of the connector; and
a second fastener extending through the second opening of the connector,
wherein rotation of the first fastener or the second fastener moves the first panel relative to the second panel.

2. The panel system of claim 1, wherein the connector includes a first alignment tab and a second alignment tab interfacing with respective openings in the first frame and the second frame.

3. The panel system of claim 1, wherein the connector includes a first inclined ramp adjacent the first opening and a second inclined ramp adjacent the second opening.

4. The panel system of claim 1, rotation of the first fastener causes the first fastener to engage the first ramp and move the first panel relative to the second panel in a first direction and rotation of the second fastener causes the second fastener to engage the second ramp and move the second panel relative to the first panel in a second direction.

5. The panel system of claim 4, wherein the first fastener includes a first inclined surface mating with the first inclined ramp.

6. The panel system of claim 1, wherein the connector includes a third opening and a fourth opening, and a first clamping fastener extends through the third opening to engage the first frame and a second clamping fastener extends through the fourth opening to engage the second frame.

7. The panel system of claim 6, wherein the connector includes a first alignment tab extending through an opening in the first frame and a second alignment tab extending through the opening in the second frame.

8. The panel system of claim 1, wherein the first frame includes a first upper rail and a first lower support and the second frame includes a second upper tail and a second lower support.

9. The panel system of claim 8, wherein a lower connector attaches to the first and second lower supports.

10. A panel comprising:
a frame having an upper portion and a downwardly extending lower support;
a leg connected to the lower support having a stem and a base; and
an anchor foot having a slot for receiving at least a portion of the leg and an anchor hole.

11. The panel of claim 10, further comprising an anchor received in the anchor hole and configured to engage a floor surface underlying the anchor foot.

12. The panel of claim 10, wherein the anchor foot includes a curvilinear depression for receiving a jamb nut connected to the stem.

13. The panel of claim 10, wherein the anchor foot includes a channel underlying the slot for receiving the base of the stem.

14. A panel comprising:
a frame having a first side, a second side, and an upper rail;
an attaching device fastened to the upper rail configured to set a height of each of the first cladding and the second cladding relative to the upper rail;
a first cladding secured to the first side of the frame by the attaching device; and
a second cladding secured to the second side of the frame by the attaching device.

15. The panel of claim 14, wherein the attaching device includes a middle portion, a side portion, and a bottom portion having an inner member and an outer member.

16. The panel according to claim 15, wherein the inner member is fastened to the upper rail at a first height and the first cladding is attached to the outer member at a second height that is greater than the first height.

17. The panel according to claim 16, wherein the outer member and inner member stepped configuration in cross section.

18. The panel according to claim 14, wherein the first cladding has a concave curved intermediate portion overlying a concave curved intermediate portion of the first side of the frame and linear portions overlying linear end portions of the first side of the frame, wherein the second cladding has a convex intermediate portion overlying a convex curved intermediate portion of the second side of the frame and linear portions overlying linear end portions of the second side of the frame.

19. The panel according to claim 18, wherein a worksurface is nested in the first cladding.

20. The panel according to claim 18 further comprising one of a screen and a worksurface coupled to a top of the frame, wherein the one of a screen and a worksurface include intermediate curved portions and opposite linear end portions overlying the frame.
